(19) United States
(12) Patent Application Publication
(10) Pub. No.: US 2007/0098586 A1
(43) Pub. Date: May 3, 2007

(54) Fuel pump

(75) Inventor: John I. Clark, Fairacres, NM (US)

Correspondence Address: FITCH EVEN TABIN AND FLANNERY, 120 SOUTH LA SALLE STREET, SUITE 1600, CHICAGO, IL, 60603-3406, US

(73) Assignee: Autotronic Controls Corporation

(21) Appl. No.: 11/261,891

(22) Filed: Oct. 28, 2005

(51) Int. Cl. F01C 1/18; F01C 1/24; F03C 2/00

(52) U.S. Cl. 418/206.1

(57) ABSTRACT

A spur-gear type fuel pump for vehicles is disclosed having a pair of interengaged gears contacting an interior surface of a pump body cavity for capturing fuel between teeth of the gears and the interior surface. The gears have a concentrically ground face that is flush against and slides over the interior surface to generally prevent or restrict fuel bleed or leakage across the interface and from between the teeth of the gears.

### FIELD OF THE INVENTION

The invention relates to a fuel pump for a vehicle and, in particular, to a spur gear pump for delivering fuel to an engine of a vehicle.

### BACKGROUND

It is currently known in the art to provide a fluid pump utilizing a pair of intermeshing gears. Often referred to as a spur gear pump, the gears cooperatively engage to rotate in the same plane, the direction of rotation determining an intake side and an output side. More specifically, the intake side is provided on a side of the gears where the teeth move out of engagement with the teeth of the other gear and generally rotate outward. The rotational movement of the gear teeth in this manner provides a vacuum or suction to draw fluid into interstices or spaces between the teeth and a pump body surrounding the gears. On the output side, the fuel is deposited as the teeth of the gears open to an output port and then intermesh, the accumulation of fuel creating a pressure to force the fluid into the output port.

High-performance racing engines such as those used in sprint and drag racing cars commonly use spur gear pumps as a fuel pump. In this case, the fuel pump draws fuel from a fuel supply on the intake side and deposits the fuel under pressure on the output side for delivery downstream to the engine intake, such as an injection system.

More specifically, many high-performance racing engines use spur gear fuel pumps to deliver alcohol or nitromethane fuel to fuel injectors for the engine. The passage of the pump surrounding the spur gears is defined by a body formed of aluminum, and the gears have a small flat face at the end of each tooth. In order to minimize damage due to contact with the aluminum body, the tooth faces are positioned a short distance or gap from the surface of the body. The size of the gap is further increased by accommodating for a range of operating temperatures. As a result, the interface between the gear teeth and the pump housing provides for fuel leakage at all operating temperatures and pressures. For a new fuel pump, this leakage or bleed is typically 3-5% of the fuel captured between adjacent teeth and up to 10% for a worn pump.

This system results in a number of problems. Ideally, the provision of fuel is linear such that the volume of fuel is in direct and exact proportion to the engine speed, as measured in revolutions per minute (RPM), regardless of pressure. Generally this linearity is attempted by rotating the gears of the pump at a direct proportion to the RPM of the engine, such as by connecting the fuel pump to the engine via the serpentine belt or the cam shaft. However, the linearity is lost due to the leakage which is exacerbated as the leakage increases as pressure increases.

In addition, the operation of the fuel pump may cause cavitation or vaporization of the fuel. The tooth faces are intentionally small to minimize the ability of the edges to contact the pump body. The vacuum at the intake created by the rotation of the gears may be sufficient to vaporize the fuel or mix air thereinto. In a vapor or gas form, it is easier for the fuel to pass between the tooth faces and the pump body, further contributing to the leakage. In any event, then the tooth face profile is combined with the narrow gap, the fuel leaking through the gap experiences a significant pressure drop. When the volatile fuel experiences this pressure drop, it often quickly vaporizes and/or cavitates.

Cavitation of the fuel at the intake or within the fuel pump leads to a number of issues. In one instance, cavitation, either through vaporization or through mixing of air into the fuel, increases the volume of a molar amount of fuel. Though the pump can continue to deliver a volume of fuel between the teeth and the pump body, the molar quantity of fuel that is deliverable as a vapor or gas is significantly reduced from that which is deliverable as a liquid. Therefore, the quantity performance for the fuel pump is reduced when the volume is fully or partially vaporized fuel or air, perhaps to a point of failing to provide the requisite amount of fuel. This effect also results in the quantity of fuel delivered being unpredictable even for constant RPM conditions, the linearity of the fuel delivery with respect to the engine speed being again lost, and the fuel delivery varying with temperature (which causes expansion of the gas or vapor). As a result, the fuel delivery to the engine may be too high or too low. Beyond this, the high-pressure of the fuel over a small area on the gear teeth and pump body causes erosion on these surfaces, reducing the serviceable life of the pump and its components.

Accordingly, there has been a need for an improved fuel pump for providing fuel to an engine in linear proportion to the engine speed and with a spur gear type fuel pump.

### SUMMARY

In accordance with one aspect, a spur-gear type fuel pump is disclosed. The fuel pump includes a pair of interengaged gears rotating in a common plane within a pump body, the gear teeth defining spaces for capturing and pumping fuel through the pump. The gear teeth rotate into contact with the interior surface to capture the fuel therebetween. The gears then rotate to pump the fuel from an intake side to an output side. The contact of the teeth with the interior surface prevents or minimizes leakage from the spaces. This allows the pump to operate at high pressure, and the high pressure aids in minimizing cavitation or vaporization of the fuel.

In accordance with a further aspect, the gear teeth have a radially oriented terminal ends including an arcuate face concentrically formed with the center of rotation of the gear. The interior surface of the pump body which is contacted by the teeth is arcuate, and the interior surface is concentrically formed with the center of rotation of the gear. As the gear teeth rotate into contact with the interior surface, the arcuate faces are flush with the arcuate interior surface. This further serves to minimize leakage across the interface therebetween.

In accordance with another aspect, the gear pair includes an idler gear positioned on a roller bearing on a fixed axle, and a driven gear. The roller bearing is provided with tolerances which allow the pressure of the driven gear to shift the idler gear relative to the fixed axle or shaft. In this manner, the idler gear can balance pressure from the driven gear, which pushes the idler gear away from the driven gear, with pressure from the pump body interior surface which pushes the idler gear towards the driven gear.

In accordance with another aspect, the driven gear is secured with an axle or drive shaft for driving the driven gear. The drive shaft includes a pair of bearing assemblies on respective ends of the drive shaft. The bearing assemblies allow the drive shaft to self-align during operation.

In an additional aspect, the fuel pump includes a casing. The pump body is secured within the casing so that a portion of the pump body extends to contact an inner surface of the casing. Preferably, the pump body contacts the inner surface of the casing in the directions in which internal pressure from the rotating gears may otherwise cause the pump body to flex outwardly. In this manner, the pump body is constrained from substantially flexing, which may otherwise lead to separation between the teeth arcuate faces and the interior surface of the pump body.

A further aspect includes selecting materials to promote predictable and linear operation of the pump over a range of temperatures. In some forms, the interior surface of the pump body is formed of a hardened material with wear characteristics providing for a long life. In some forms, the gears are formed of a hardened material with similar long-life wear characteristics. In some forms, the gears and interior surface have different surface grain size to minimize gripping or locking between the gears and the interior surface. In some forms, the materials of the gears and of the interior surface may have similar or closely matched coefficients of thermal expansion so that, as the temperature of the pump increases, the gears and pump body expand in similar or closely matched amounts. In one example, the gears may be formed of hardened bearing-grade steel, and the interior surface may be formed of a hardened bronze alloy such as silicon bronze. In a further form, the pump body may be formed of a lightweight material such as aluminum or titanium, and the interior surface may be lined or covered with the hardened material such as the bronze alloy.

In another aspect, the pump gears may be rotated in either direction for operation. In this manner, the pump may be mounted in a variety of configurations and locations in an engine compartment. The pump communicates with a fuel source to receive fuel and with the engine to deliver fuel thereto, such as via a fuel injection system, and passageways are provided for the respective fuel receipt and fuel delivery. The passageways are generally identical so that the direction of the rotation of the pump gears may be selected based on which passageway is output and intake, or vice versa.

### BRIEF DESCRIPTION OF THE DRAWINGS

In the drawings, FIG. 1 is a front elevation view of a portion of a fuel pump including a driven gear and an idler gear showing the gears engaging an interior surface of a pump body, the gears cooperating to draw fuel between ports of the pump body;

FIG. 2 is a perspective view of a gear of a prior art spur gear pump;

FIG. 3 is a front elevation view of the prior art gear of FIG. 2;

FIG. 4 is a perspective view of a gear of FIG. 1 showing faces on the ends of teeth of the gear;

FIG. 5 is a front elevation view of the gear of FIG. 4 showing the faces arcuately shaped and concentric with a center of rotation of the gear;

FIG. 6 is a front perspective view corresponding to FIG. 1 showing the driven gear fixedly engaged with a driven axle for driving the driven and idler gear, and showing a bearing assembly between the idler gear and an axle around which the idler gear rotates;

FIG. 7 is a rear perspective view of the portion of FIG. 1 showing front and rear bearing assemblies for supporting the driven axle;

FIG. 8 is a rear elevation view corresponding to FIG. 7 showing the ports of the pump body;

FIG. 9 is a front perspective view corresponding to FIG. 6 showing a body cover on the pump body and an exploded thrust bearing assembly for the driven axle;

FIG. 10 is a rear perspective view corresponding to FIG. 9 showing a bearing housing for the rear bearing assembly and the exploded thrust bearing assembly;

FIG. 11 is a front perspective view similar to FIG. 9 showing a pump casing for housing the pump body and gears;

FIG. 12 is a front perspective view corresponding to FIG. 11 showing the fuel pump including a casing cover secured with the pump casing;

FIG. 13 is a right side elevation view of the fuel pump showing the pump casing having a first pair of openings communicating with one of the ports of the pump body;

FIG. 14 is a left side elevation view of the fuel pump similar to FIG. 13 showing the pump casing having a second pair of openings for communicating with a second one of the ports of the pump body;

FIG. 15 is a rear elevation view of the fuel pump showing a configuration of the pump casing for providing the first and second pairs of openings of FIGS. 13 and 14;

FIG. 16 is a cross-sectional view taken through the line 16-16 of FIG. 14 showing passageways between the ports of the pump body and the pairs of openings of the pump casing; and

FIG. 17 is a top plan view of the fuel pump along the line 17-17 of FIG. 15 showing the passageways communicating between the pairs of openings of the pump casing.

### DESCRIPTION OF THE PREFERRED EMBODIMENTS

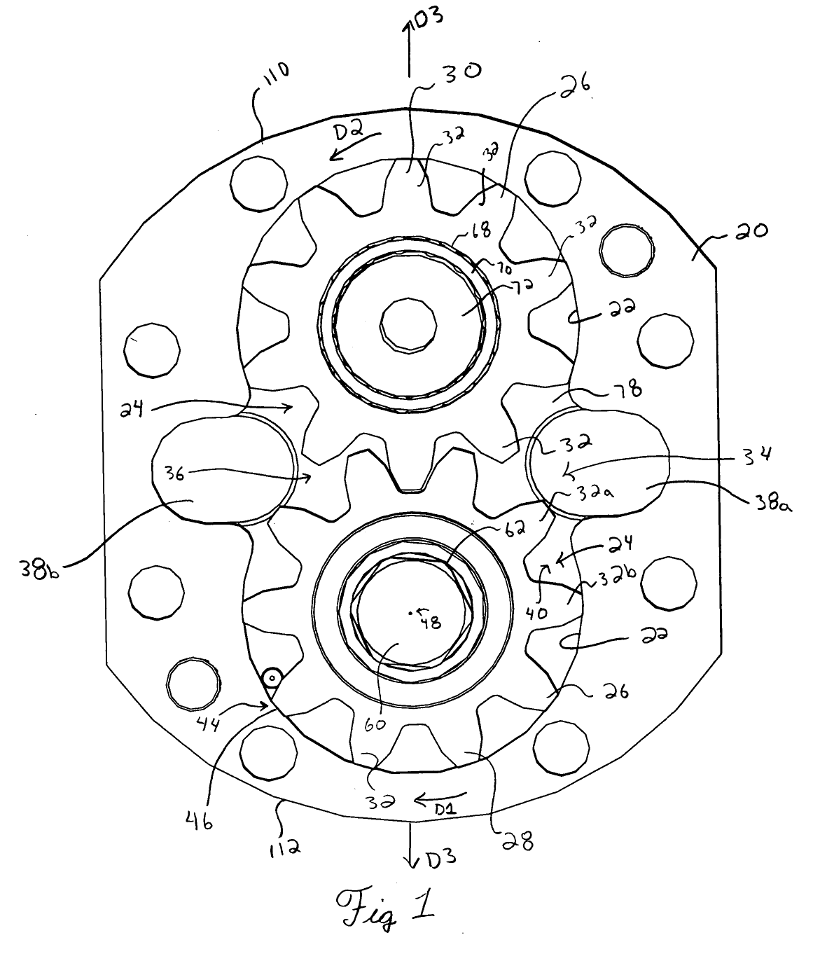

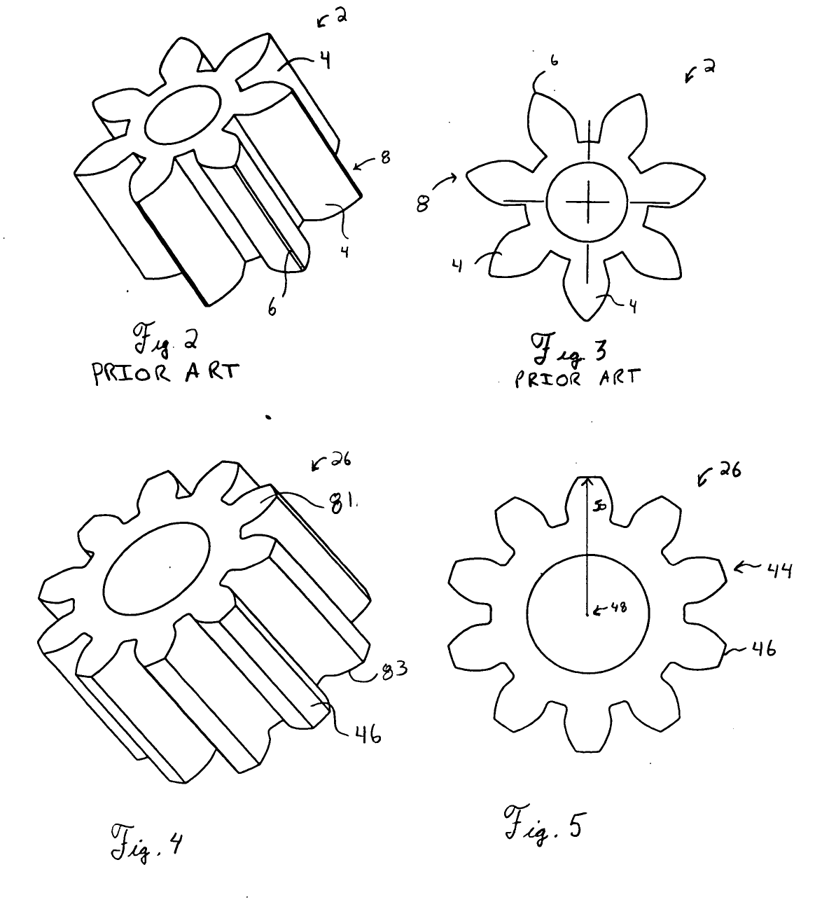

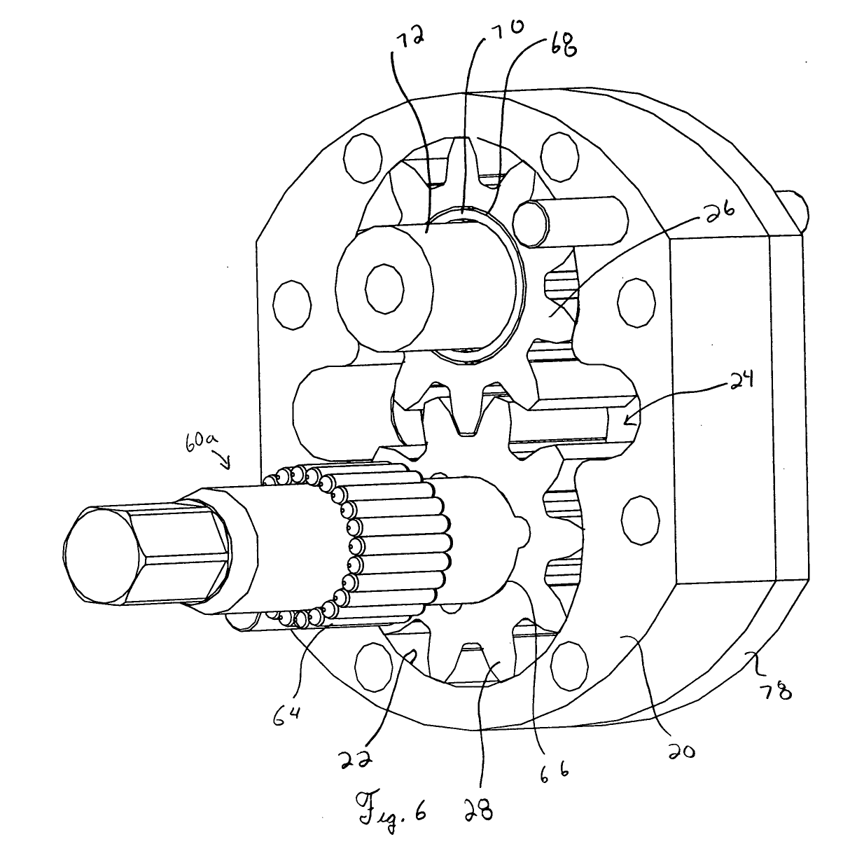

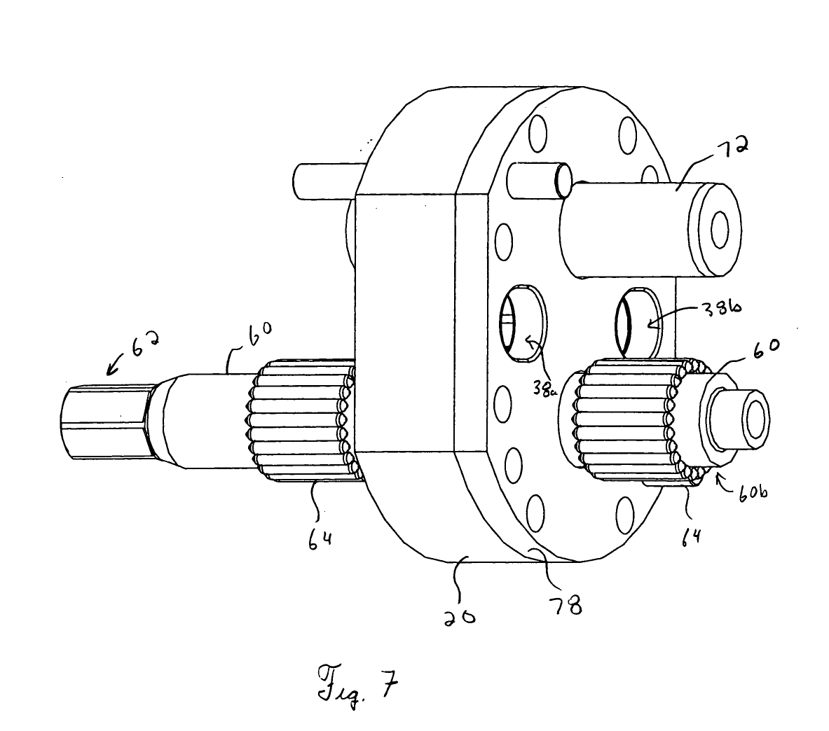

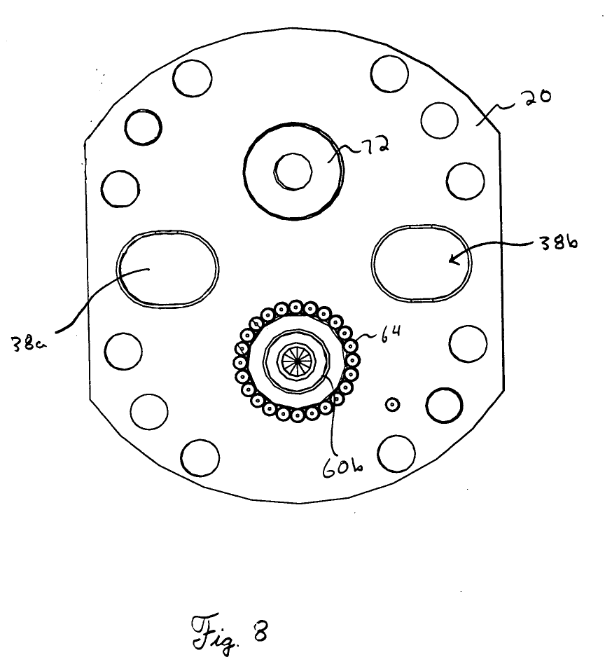

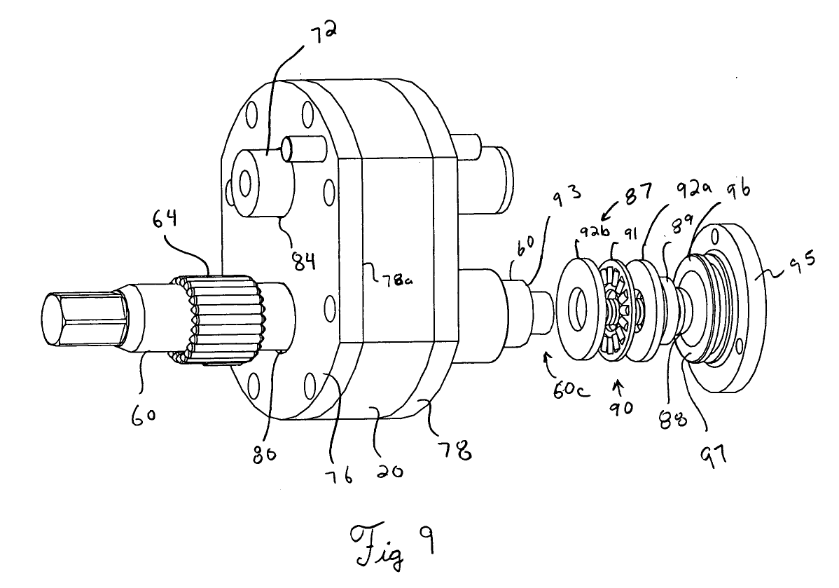

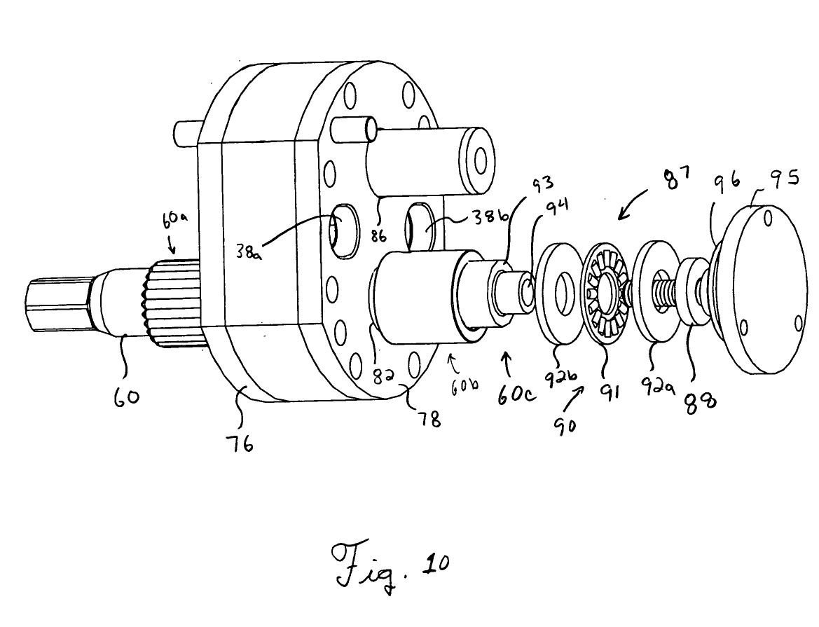

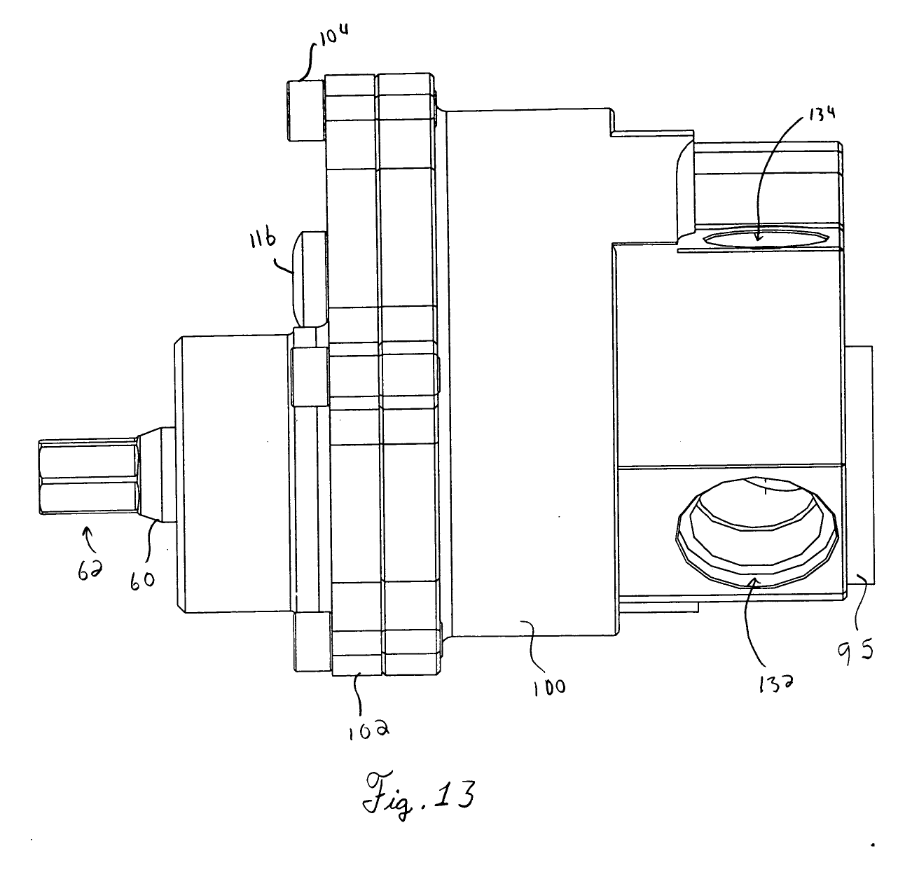

Referring initially to FIG. 1, a body 20 having an interior surface 22 defining a cavity 24, and a pair of gears 26 engaged with and contacting the interior surface 22 are shown for providing an operation portion of a fuel pump 10 (see FIG. 12). A prior art fuel pump (not shown) utilizes gears 2 having teeth 4 radially extending therearound. The teeth 4 have a small face 6, or are pointed, at the ends 8 of each, as can be seen in FIGS. 2 and 3. As discussed above, these prior art gears 2 are sized to provide a clearance or gap between the ends 8 and the interior surface 22 of the body 20, allowing fuel to leak therebetween. As shown in FIG. 1, the present gears 26 contact with the interior surface 22 to minimize or generally prevent fuel crossing across the interface therebetween.

More specifically, the gears 26 include a driven gear 28 and an idler gear 30. Each of the gears 26 includes gear teeth 32 for cooperatively engaging with teeth 32 on the other of the gears 26 so that the engaged gears 26 rotate together in the same plane, though in opposite directions. As the driven gear 28 rotates in a first direction, the idler gear 30 rotates in the opposite direction to create a reduced-pressure suction or vacuum on one side 34 of the gears 28 at which the gears 28 dis-engage and rotate outward, and to create an increased pressure on an opposite side 36 of the gears 28 at which the gears 28 intermesh.

Each of these sides 34, 36 is positioned adjacent a port 38 in the pump body 20. One of the ports 38 is an intake port and the other is an output port, the selection of which is determined by the direction of driving the driven gear 28. In other words, the fuel pump 10 may be used so that one of the ports 38 is an intake port 38a through which fuel is received into the body 20 from a fuel source, and the other of the ports 38 is an output port 38b through which fuel is delivered to the engine (not shown) such as through an injection system (not shown). Accordingly, the driven gear 28 rotates in a direction indicated by arrow D1, and the idler gear 30 cooperatively engaged with the driven gear 28 rotates in an opposite direction indicated by arrow D2. This produces the suction on a side 34 coincident with or adjacent the intake port 38a and an increased pressure on a side 36 coincident with or adjacent the output port 38b, as shown in FIG. 1.

The teeth 32 of the gears 26 capture fuel received on the intake side 34 between the teeth 32 and the body interior surface 22. As the teeth on one gear rotate outward and away from the teeth of the opposite gear, a quantity of fuel is captured between consecutive teeth of each gear and the interior surface 22. Representatively and with specific reference to FIG. 1, the driven gear 28 includes first and second teeth 32a and 32b with a space 40 therebetween that is exposed to the intake port 38a and fuel therefrom. With the first tooth 32a contacting the interior surface 22, the driven gear 28 rotates in the direction D1 so that the space 40 including fuel therein rotates so that the second tooth 32b is also in contact with the interior surface 22. Once the teeth 32a, 32b rotate to the output side 36 adjacent the output port 38b, the fuel may be released from the space 40. In any event, as the teeth 32a, 32b cooperatively engage with a tooth of the idler gear 30, the fuel is forced out of the space 40 so that it remains on the output side 36. Thus, the fuel accumulates on the output side 36 to create a pressure which forces the fuel through the output port 38b and to the engine. As noted above, the rotation of the gears 26 may be reversed such that the intake port would be represented by port 38b and the output port would be represented by port 38a. As can be seen in FIG. 1, the teeth 23 are in contact with the interior surface 22 for approximately two hundred twenty degrees of angular rotation.

As shown, each of the gears 26 includes approximately ten teeth 32, though this number may range up to fifteen or more in the preferred embodiments. As can also be seen in comparing FIGS. 3 and 5, each of the gears 26 is diametrally larger than the prior art gears 2 to provide a greater space between consecutive teeth 32 for capturing fuel.

Each of the gear teeth 32 includes a terminal end 44 for contacting the interior surface 22. As the gears 26 rotate, the teeth 32 will sequentially contact and slide against the interior surface 22 to prevent fuel bleed or leakage between the teeth 32 and the interior surface 22. By doing so, the above-described problems associated with leakage are substantially reduced or eliminated.

Additionally, this allows the fuel pump 10 to operate at a significantly greater pressure than those of the prior art. Under high pressure, a prior art pump will leak, vaporize a percentage of the fuel, and/or cavitate the fuel, thereby rendering the pump inadequate for its purpose. In a partial attempt to reduce these effects, the prior art pump is generally run at a maximum of 75-80 psi. The construction of the fuel pump 10 described herein allows for operation in the range of 400-500 psi, thus allowing for efficient fuel delivery across a wider range of pressures and temperatures and engine speeds without a loss of linearity between the speed and the volume of fuel delivered. The increased operating pressure for the fuel pump 10 also serves to minimize vaporization of the fuel on the intake side 34 due to the vacuum created. It is preferred for the fuel pump 10 to operate with a revolutions per minute speed that is approximately one-half the RPM speed of the engine. For high-performance engines, the engine RPM may be in the order of 4,000-12,000 RPM so that the pump 10 operates at 2,000-6,000 RPM. The pump 10 is also expected to operate properly at least through the temperature range of 30-200° F.

The terminal ends 44 include a radially located face 46. The face 46 is arcuately shaped with a center of curvature located with a center of rotation 48 of each gear 26. Therefore, each point along the face 46 is generally positioned at a radius 50 for the gear 26, as shown in FIG. 5. Preferably, the radius 50 is 0.5-1 inches. By having the full surface of the face 46 in contact with the interior surface 22, the contact generally inhibits fuel entrapment therebetween. Again, this serves to inhibit fuel leakage from a high-pressure zone to a low-pressure zone which may otherwise result in vaporization. To ensure close mating between the faces 46 of the teeth 32 and the interior surfaces 22, each is manufactured with a tolerance in the order of 0.00025 inches from the center of rotation 48.

Each of the gears 26 is positioned on a concentric shaft. For the driven gear 28, a drive shaft 60 is provided having a socket 62 at one end for engagement with other drive components of the vehicle. For instance, the drive socket 62 may be coupled with the engine cam shaft, with the serpentine belt, or with another system for providing a speed ratio for the desired pump speed relative to the engine speed. The drive shaft 60 includes a pair of bearing assemblies 64a, 64b on respective front and rear portions 60a, 60b with the driven gear 28 positioned therebetween. The driven gear 28 includes a central opening 66 through which the drive shaft 60 is positioned, the drive shaft 60 and driven gear 28 being non-rotationally secured so that they co-rotate. The idler gear 30 includes a central opening 68 in which a bearing assembly 70 is positioned. The bearing assembly 70 is further positioned around an idler shaft 72.

As can be seen in FIG. 9, the cavity 24 of the pump body 20 may be enclosed by a body cover 76, as well as the interior surface 22 of the body 20 and a body rear plate 78 including the ports 38. Each of the cover 76 and rear plate 78 include aligned bores for receiving the shafts 60, 72 therethrough. Specifically, the cover 76 includes a throughbore 80 aligned with a throughbore 82 of the rear plate 78 for the drive shaft 60, and the cover 76 and rear plate 78 have aligned throughbores 84 and 86 for receiving the idler shaft 72. The drive shaft 60 is permitted to rotate within the throughbores 80, 82 and within the bearing assemblies 64. The bearing assemblies 64 are preferably long roller bearings which provides a self-centering capability for the drive shaft 60, which in turn facilitates a close-tolerance fit of the driven gear 28 the pump body 20, the cover 76, and the rear plate 78, discussed in greater detail below.

The idler shaft 72 is secured with the throughbores 84, 86 so that it generally remains stationary with respect to the body 20. In prior art systems, the idler gear is fixed with its shaft or axle, which itself would have a bearing assembly at each axle end in the same manner as the drive shaft 60. The prior art configuration is designed to preserve the gap size between the gear teeth and the body surface. In contrast, the present idler shaft 72 is held stationary and the idler gear 30 rotates around the single bearing assembly 70 so that the tolerances allow a small amount of shifting of the idler shaft 72. In this manner, the idler shaft 72 can balance the pressure from its cooperative engagement with the driven gear 28 with pressure against the interior surface 22 of the body 20. This allows the idler shaft 72 and idler gear 28 to self-align and to maintain contact with the interior surface 22.

During operation, the gears 26 contact the pump body 20, rear plate 78, and cover 76 to prevent fuel leakage. As discussed above, the faces 46 of the gears 26 contact the interior surface 22 to prevent leakage across their interface. Furthermore, the gears 26 each have a top surface 81 and a bottom surface 83 which respectively contact the cover 76 and the rear plate 78. In this manner, fuel movement is generally restricted to being pumped through the spaces 40 between the teeth 32 and the interior surface 22 as the gears 26 rotate. Lubrication is provided by the fuel itself.

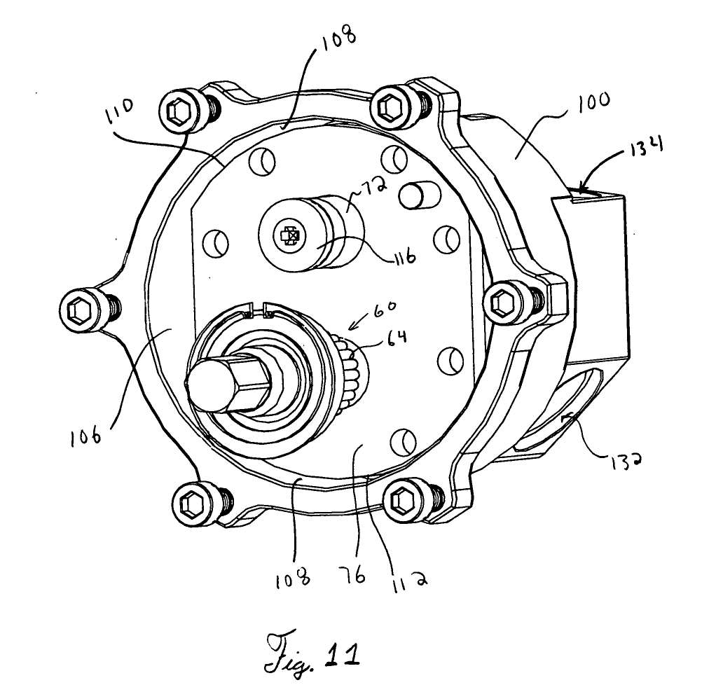

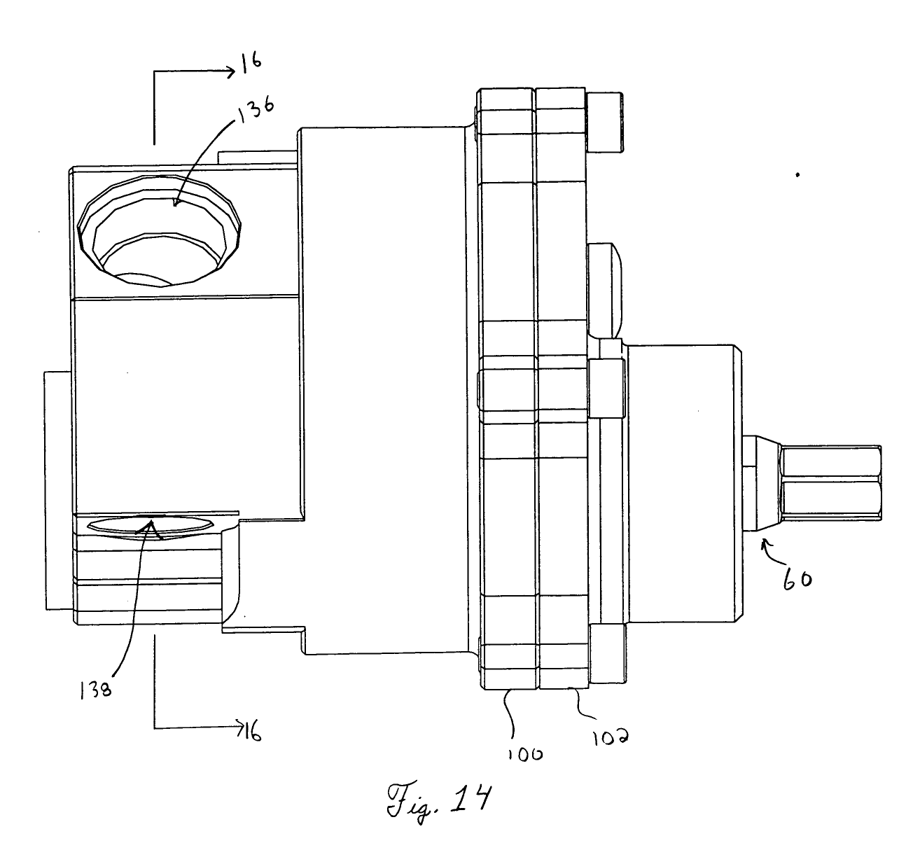

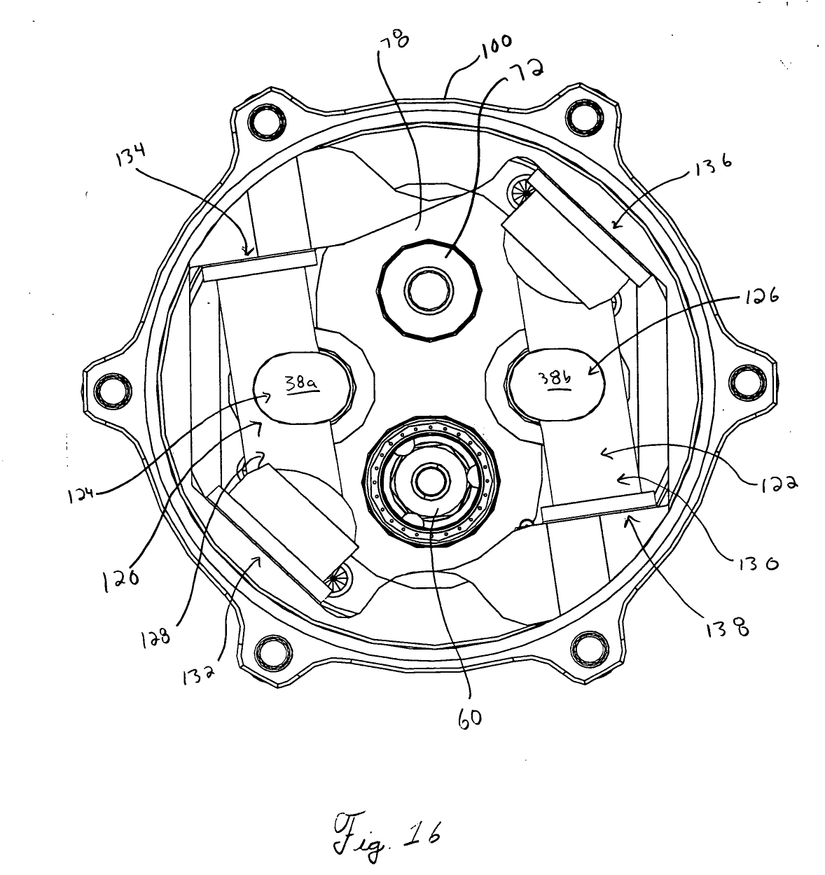

In greater detail, the drive shaft 60 includes a thrust bearing assembly 87 so that forces exerted on the drive shaft 60 do not create excessive friction between the top and bottom surfaces 81, 83 of the driven gear 28. The thrust bearing assembly 87 is secured to a terminal rear end 60c of the drive shaft by a bolt 88 and washer 89. A thrust bearing 90 including a cage 91 having rollers is positioned between a pair of races 92a, 92b, and one of the races 92a is positioned against the washer 89 while the other race 92b is positioned against a shoulder 93 on drive shaft terminal end 60c and around a threaded bore 94 therein for receiving the bolt 88. A securing cap 95 is positioned with an annular portion 96 positioned around the bolt 88 and washer 89 so that a leading face 97 is positioned against the race 92a. As can be seen in comparing FIGS. 10 and 9 with FIGS. 13 and 15, the securing cap 95 is then secured on a rear side 100a of a casing 100, discussed below.

As such, the thrust bearing 90 prevents axial loads on the drive shaft 60 from forcing the driven gear 28 into either the body cover 76 or the rear plate 78. When an axial load is directed in a push direction into the drive shaft 60, that is, along the axis from the front portion 60a towards the rear portion 60b, the drive shaft shoulder 93 presses against the thrust bearing 90 (specifically, the race 92b), which in turn presses against the securing cap 95 secured with the casing 100. When an axial load is directed in a pull direction, opposite the push direction, the bolt 88 secured with the drive shaft 60 presses against the thrust bearing 90 (specifically, the race 92a), which in turn is secured within a step (not shown) formed within the casing 100. Accordingly, the drive shaft 60 is assembled with the thrust bearing 90 through the casing rear side 100a, and the securing cap 95 is then sealed and secured with the casing rear side 100a.

A number of considerations are presented with maintaining the contact between the tooth faces 46 and the interior surface 22. In prior art fuel pumps, inadvertent contact between the gears 2 and an interior surface leads to galling or smearing of the material. That is, the gears 2 grab and lock with the interior surface, leading to rapid and excessive wear, if not failure. To minimize wear between the present gears 26 and the interior surface 22, the gears 26 are formed of a high-strength steel such as a bearing-grade material. An example of this is AISI 8640 steel. In a preferred embodiment, the interior surface 22 is formed of an alloy such as a hardened bronze alloy, one example of which is silicon bronze. This provides wear resistant characteristics and a coefficient of friction that are generally similar to or matched with the same for the steel of the gears 26.

By utilizing different materials for the gears 26 and the interior surface 22, these characteristics are also matched but have different surface structural granularity. That is, the microscopic grain size of the materials on the contact surface is mismatched. Accordingly, the materials have a lower tendency to grab and lock with each other. The faces 46 and the interior surface 22 are highly polished to further reduce any tendency to grab and lock.

In a more preferred embodiment, the body 20 is made of a lightweight material such as aluminum or titanium that is lined with the bronze alloy on the interior surface 22. It is noted that aluminum is corroded by nitromethane and alcohol fuels. Accordingly, the interior surface 22 formed of a hardened bronze alloy provides a longer life to the fuel pump 10.

The contact between the gears 26 and the interior surface 22 is maintained over a range of temperature. The described materials for the gears 26, body 20, and interior surface 22 generally provide for similar amount of expansion or contraction due to heat. Though not exactly matched, the thermal expansion coefficients combined with the bearing assemblies of the shafts 60, 72 allow differences in pressure to equilibriate so that contact between the gears 26 and the interior surface 22 is maintained.

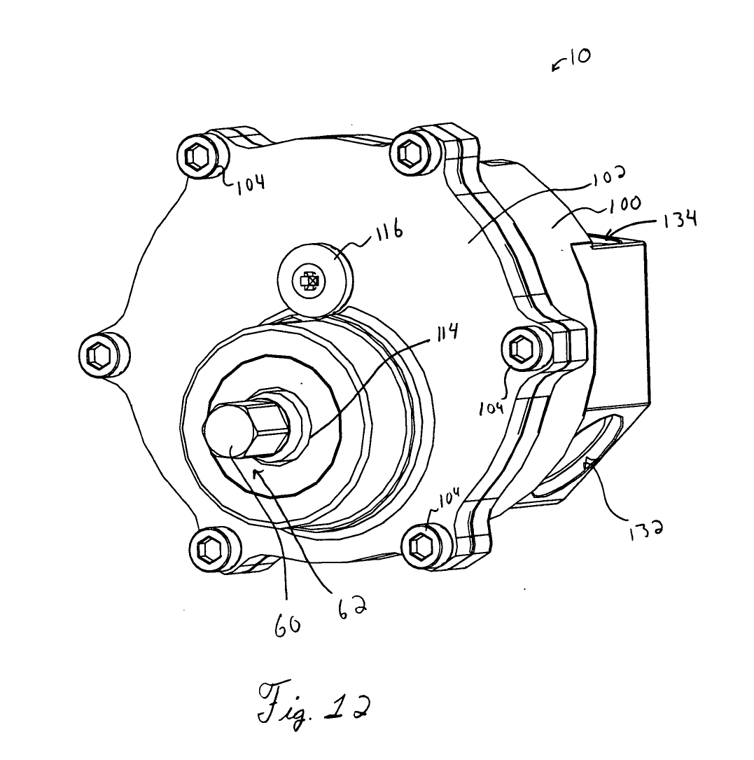

Referring now to FIGS. 11 and 12, the pump casing 100 is shown with the pump body 20 and cover 76 secured therein. In specific, FIG. 12 shows a casing cover 102 secured on the casing 100 to enclose the pump body 20 with the drive shaft 60 extending therethrough so that the drive socket 62 is exposed for connection with other engine components. The casing cover 102 is secured with the casing 100 via bolts 104 around a perimeter portion. The casing cover 102 and casing 100 form a generally sealed compartment 106 therewithin so that a pressure can be maintained within the pump body 20.

It should also be noted that the pressure within the casing 100 and, in specific, the compartment 106 is maintained at the output pressure. The output side 36 of the pump body 20 is permitted to leak or is provided with a small port so that, within a brief time from pump start-up, the internal pressure within the compartment 106 is balanced with the output pressure. The pressure is thus generally balanced within the casing 100 and the pump body 20. More precisely, the pressure inside and outside the pump body 20 is generally balanced so that the rear plate 78 and front cover 76 do not bulge during high-pressure operation. Otherwise, this bulging would cause the fuel in the pump to flow around the top and bottom surfaces 81, 83 of the gears 26 and between the gears 26 and the front cover 76 and rear plate 78, leading to inefficiency and loss of performance.

In greater detail, it should be recognized that the pump body 20 has a first pressure at the intake side 34 which is lower than a pressure at the output side 36. In a prior art fuel pump, a seal such as an O-ring is located between the front cover 76 and body 20. In forms of the present fuel pump 10, the seal is omitted allowing the pressure from the intake and output sides 34, 36 to leak to the compartment 106 around the body 20 and within the casing 100. The front cover 76 and body 20 are in direct contact, such as along an interface 78a, that is not sealed such that the pressure is allowed to leak across the interface 78a (FIG. 9). On initial start up, the pressure in the compartment rises to a pressure dependent on the combined pressures at the intake and output sides 34, 36.

However, the combined pressure in the compartment 106 is greater than the pressure at the intake side 34. Therefore, this combined pressure tends to force the cover 76 and body 20 together proximate the intake side 34. As this happens, the compartment combined pressure will rise as the pressure at the output side 36 imparts a greater contribution to the combined pressure, which further serves to close the intake pressure off from the compartment 106. Eventually, the pressures equilibrate with the compartment pressure generally approximately, or equal to, the pressure at the output side 36. In this manner, the pressure in the compartment 106 is substantially as high as pressure within the pump body 20, thereby substantially eliminating problems due to bulging of portions of the body 20 or the front cover 76 or rear plate 78. It should be noted that, though described for the front cover 76 and the body 20, a seal may also or may alternatively be omitted between the body and the rear plate 78 such the interface 78a may be located therebetween.

The casing cover 102 also serves to secure the drive shaft 60 and the idler shaft 72. The drive shaft 60 is permitted to rotated within and extend through a throughbore 114 in the casing cover 102. To maintain pressure within the casing compartment 106, the drive shaft 60 is sealed with the casing cover 102. A portion (not shown) of the casing cover 102 extends into the compartment 106 for receiving the bearing assembly 64a on the front portion 60a of the drive shaft 60. The idler shaft 72, which is stationary with the casing 100, is secured in the casing cover 102 with a bolt 116.

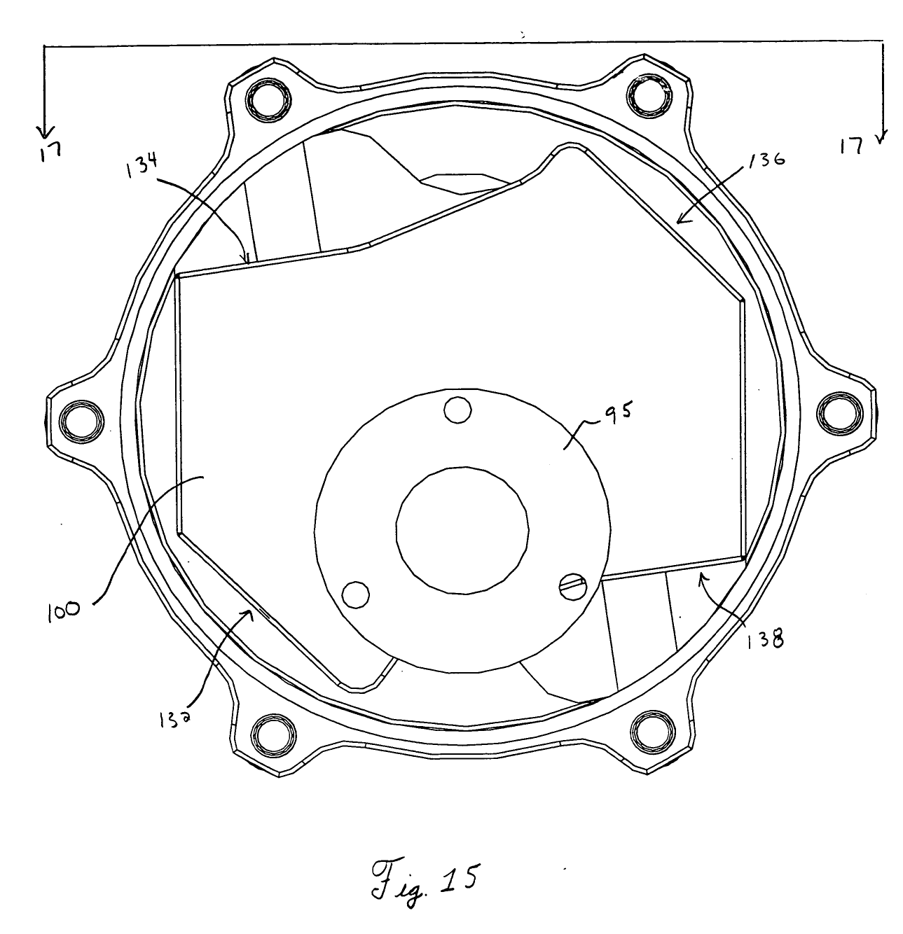

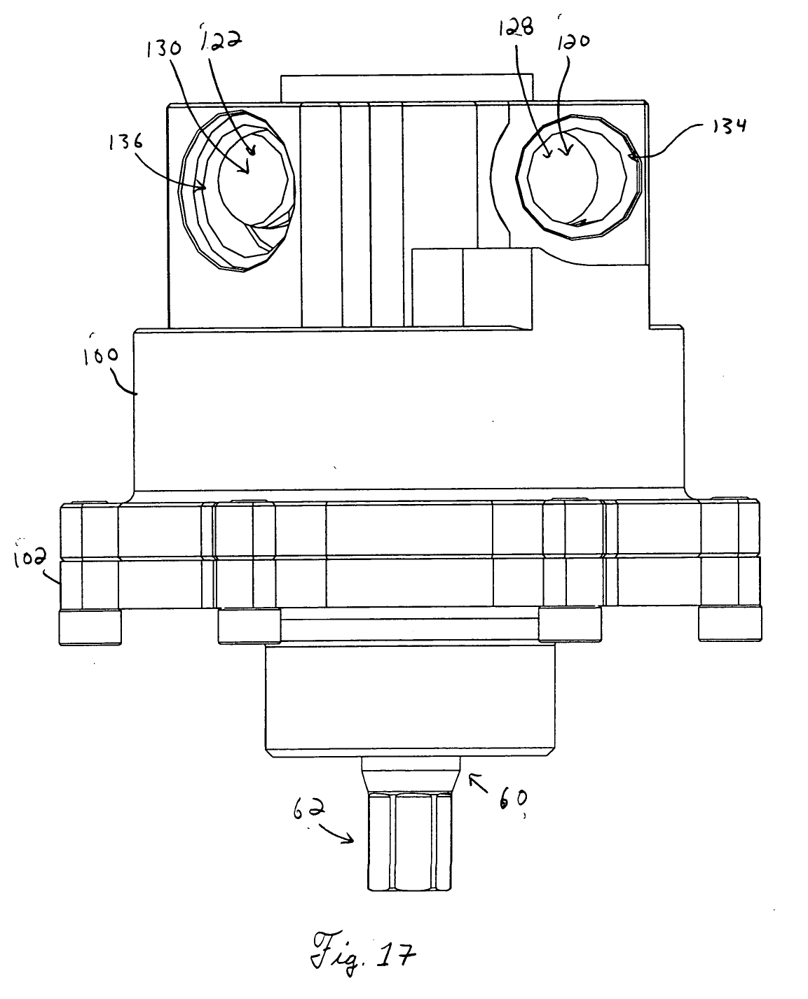

Referring now to FIGS. 13-17, openings for communicating with the intake and output ports 38a, 38b are depicted. More specifically, the rear plate 78 is sealed with the casing 100. The casing 100 includes an intake passageway 120 aligned with and sealed with the intake port 38a so that fuel can be delivered from the fuel source through the passageway 120 to the intake port 38a. The casing 100 further includes an output passageway 122 generally identical to the intake passageway 120, though aligned with and sealed with the output port 38b for receiving fuel therefrom and from the output side 36.

Each of the passageways 120, 122 communicates with a pair of openings for either receiving or delivering fuel therethrough. Each passageway 120, 122 includes a first portion 124, 126 that is generally axially aligned and parallel to the axis of rotation of the drive shafts 60, 72. A first end of each first portion 124, 126 communicates with the respective intake and output ports 38a, 38b, while a second end of each first portion 124, 126 communicates with a second portion 128,130 of the respective passageways 120, 122. Each second portion 128, 130 is oriented generally transverse or orthogonal to the first portions 124, 126 and includes respective openings for fuel communication.

In greater detail, the second portion 128 of the intake passageway 120 includes a pair of openings 132, 134, while the second portion 130 of the output passageway 122 includes a pair of openings 136, 138. This allows each of the passageways 120, 122 to be connected in fuel communication with the fuel source and with the engine, such as through the injection system, in a variety of locations within the engine compartment and with a variety of components, such as the cam shaft or serpentine belt. Additionally, it allows the operation of the pump 10 to be reversed, as noted above, depending on its mounting location and user preference.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A fuel pump for a vehicle comprising:
a body portion defining an interior cavity having an interior surface;
an intake port for receiving fuel into the interior cavity;
an output port for delivering fuel downstream from the body cavity; and
a pair of gears at least one of which is rotationally driven to operate the fuel pump and having a plurality of radially positioned gear teeth having spaces therebetween, wherein the gear teeth of the respective gears engage and disengage during rotation thereof, and each gear is sized so that the teeth thereon rotate into and out of contact engagement with the interior surface.

2. The fuel pump of claim 1 wherein each tooth has a terminal end having an radially positioned surface formed thereon for contacting the cavity interior surface during rotation.

3. The fuel pump of claim 2 wherein the tooth surface is arcuate having a center of curvature concentric with a center of rotation of the gear.

4. The fuel pump of claim 2 wherein the tooth surface is formed of a first metal, and the interior surface is formed of a second metal different from the first metal.

5. The fuel pump of claim 4 wherein the first metal has a first surface grain size, the second metal has a second surface grain size, and the first and second grain sizes are generally different to minimize friction therebetween.

6. The fuel pump of claim 4 wherein the first metal is bearing-grade steel, and the second metal is a bronze alloy.

7. The fuel pump of claim 4 wherein the first metal and second metal have similar coefficients of friction.

8. The fuel pump of claim 1 wherein the gears are formed of a first material having a first thermal expansion coefficient, and the interior surface is formed of a second material having a second thermal expansion coefficient similar to the first thermal expansion coefficient.

9. The fuel pump of claim 1 wherein the gears are formed of a first material having a first thermal expansion coefficient, and the pump body is formed of a second material having a second thermal expansion coefficient similar to the first thermal expansion coefficient, and pump body comprises a liner formed of a third material and including the interior surface.

10. The fuel pump of claim 1 wherein the pump is lubricated by fuel passing therethrough.

11. The fuel pump of claim 1 wherein each gear includes a central portion for cooperating with a shaft for rotation, the gears include a driven gear and an idler gear, the driven gear generally co-rotates with a driven shaft in a first direction for operating the pump, the engagement between the driven gear and the idler gear rotates the idler gear in a second direction opposite the first direction, the idler gear is positioned around a stationary shaft, and a bearing assembly is positioned between the idler gear and the stationary shaft.

12. The fuel pump of claim 11 wherein the bearing assembly is a long roller bearing assembly having specified tolerances allowing the idler gear to shift and balance a force between the cavity interior surface and the driven gear.

13. The fuel pump of claim 1 wherein each gear includes a central portion for cooperating with a shaft for rotation, the gears include a driven gear and an idler gear, the driven gear generally co-rotates with a driven shaft in a first direction for operating the pump, the engagement between the driven gear and the idler gear rotates the idler gear in a second direction opposite the first direction, the idler gear is positioned around a stationary shaft, and the driven shaft has first and second ends each having a bearing assembly located thereon for positioning the shaft with a fuel pump casing.

14. The fuel pump of claim 13 wherein the bearing assemblies are long roller bearing assemblies having specified tolerances allowing the driven gear to self-align with the idler gear and the cavity interior surface.

15. The fuel pump of claim 1 wherein the teeth are in sliding contact with an angular sweep of at least 180° of the interior surface.

16. The fuel pump of claim 15 wherein the teeth are in sliding contact with an angular sweep of at least 220° of the interior surface.

17. A fuel pump for a vehicle comprising:
a body portion defining an interior cavity having an interior surface;
an intake port for receiving fuel into the interior cavity;
an output port for delivering fuel downstream from the body cavity; and
a pair of gears at least one of which is rotationally driven to operate the fuel pump and having a plurality of radially positioned gear teeth having spaces therebetween, wherein the gear teeth of the respective gears engage and disengage during rotation thereof, each gear includes a central portion for cooperating with a shaft for rotation, the gears include a driven gear and an idler gear, the driven gear generally co-rotates with a driven shaft in a first direction for operating the pump, the engagement between the driven gear and the idler gear rotates the idler gear in a second direction opposite the first direction, the idler gear is positioned around a stationary shaft, and a bearing assembly is positioned between the idler gear and the stationary shaft.

18. The fuel pump of claim 17 wherein the bearing assembly is a long roller bearing assembly having specified tolerances allowing the idler gear to shift and balance a force between the cavity interior surface and the driven gear.

19. The fuel pump of claim 17 wherein the driven shaft has first and second ends each having a bearing assembly located thereon for positioning the shaft with a fuel pump casing.

20. The fuel pump of claim 19 wherein the bearing assemblies are long roller bearing assemblies having specified tolerances allowing the driven gear to self-align with the idler gear and the cavity interior surface.

21. A fuel pump for a vehicle comprising:
a body portion defining an interior cavity having an interior surface;
an intake port for receiving fuel into the interior cavity;
an output port for delivering fuel downstream from the body cavity; and
a pair of gears at least one of which is rotationally driven to operate the fuel pump and having a plurality of radially positioned gear teeth having spaces therebetween, wherein the gear teeth of the respective gears engage and disengage during rotation thereof, each tooth has a radially positioned terminal end, and the tooth surface is formed of a first material, and the interior surface is formed of a second material different from the first material.

22. The fuel pump of claim 21 wherein the first material is a first metal having a first surface grain size, the second material is a second metal having a second surface grain size, and the first and second grain sizes are generally different to minimize friction therebetween.

23. The fuel pump of claim 21 wherein the first material is bearing-grade steel, and the second material is a bronze alloy.

24. The fuel pump of claim 21 wherein the first material and second material have similar coefficients of friction.

25. The fuel pump of claim 21 wherein each gear is formed of a first material having a first thermal expansion coefficient, and the interior surface is formed of a second material having a second thermal expansion coefficient similar to the first thermal expansion coefficient.

26. The fuel pump of claim 21 wherein the gears are formed of a first material having a first thermal expansion coefficient, and the pump body is formed of a second material having a second thermal expansion coefficient similar to the first thermal expansion coefficient, and pump body comprises a liner formed of a third material and including the interior surface.

27. A fuel pump for a vehicle comprising:
a body portion defining an interior cavity having an interior surface;
an intake port for receiving fuel into the interior cavity;
an output port for delivering fuel downstream from the body cavity;
a pair of gears located in the body portion cavity and against the interior surface thereof, at least one of the gears being a driven gear rotationally driven to operate the fuel pump, each gear having a plurality of radially positioned gear teeth having spaces therebetween and cooperating with the other gear so the gear teeth of the respective gears engage and disengage during rotation thereof; and
a drive shaft rotatable along a central longitudinal axis and secured with the driven gear for providing rotational power thereto, the drive shaft configured to resist axial shifting due to forces directed along the longitudinal axis.

28. The fuel pump of claim 27 further including a thrust bearing assembly cooperable with the drive shaft to resist axial forces thereto.

29. The fuel pump of claim 28 further including a casing positioned around the body portion, wherein the thrust bearing assembly transmits axial forces on the drive shaft to the casing.

30. The fuel pump of claim 29 wherein the thrust bearing assembly is pressed between a first portion of the casing and a first portion of the drive shaft when an axial force is directed generally in a first axial direction, and the thrust bearing assembly is pressed between a second portion of the casing and a second portion of the drive shaft when an axial force is directed generally in a second axial direction opposite to the first axial direction.

31. The fuel pump of claim 29 wherein the first portion of the drive shaft is an annular shoulder formed on the drive shaft, and the second portion of the drive shaft is a securing member for retaining the bearing assembly with the drive shaft.

32. A fuel pump for a vehicle comprising:
a body portion defining an interior cavity having an interior surface;
an intake port for receiving fuel into the interior cavity;
an output port for delivering fuel downstream from the body cavity;
a pair of gears located in the body portion cavity cooperable for pumping fuel from an intake side proximate the intake port to an output side proximate the output port; and
a casing surrounding the body portion, wherein a pressure within the casing is generally maintained equivalent to a pressure within the body portion cavity.

33. The fuel pump of claim 32 wherein the pressure within the body portion cavity is a pressure at the output side.

34. The fuel pump of claim 32 wherein the body portion includes a first and second portion, wherein pressure is permitted to leak through an interface therebetween to balance the pressure within the casing with the pressure within the body portion cavity.

35. The fuel pump of claim 32 wherein the pressure within the casing is lower than the pump body pressure at start-up, and the pressures generally equilibrate within a relatively short period of time.
